(19) United States
(12) Patent Application Publication
(10) Pub. No.: US 2011/0306511 A1
(43) Pub. Date: Dec. 15, 2011

(54) METHODS FOR MULTIPLEX ANALYTE DETECTION AND QUANTIFICATION

(75) Inventor: Peter Lea, Toronto (CA)

(73) Assignee: SQI DIAGNOSTICS SYSTEMS INC., Toronto, ON (CA)

(21) Appl. No.: 12/998,991

(22) PCT Filed: Dec. 29, 2009
(86) PCT No.: PCT/CA2009/001899

§ 371 Date: Aug. 22, 2011

(30) Foreign Application Priority Data
Dec. 29, 2008 (CA) 2,647,953

(51) Int. Cl. C40B 30/04

(52) U.S. Cl. 506/9

(57) ABSTRACT

The application refers to a method for detecting and quantifying multiple target analytes in a test sample using a single reaction vessel. The method uses a reaction vessel (a multi-well plate), which comprises a microarray of: (a) calibration spots, each having a predetermined quantity of the target analyte; and (b) capture spots, each having an agent (antibody) that selectively binds the target analyte. The captured analytes and the calibration spots are detected with fluorescently labelled antibodies specific for each different target analyte. The calibration spots are used to generate calibration curves that allow the measurement of the concentration of the different target analytes. The application also refers to a method for detecting and quantifying biomarkers that are useful for diagnosing rheumatoid arthritis. More specifically, the application discloses the use of rheumatoid factor (RF) and cyclic citrullinated peptide (CCP), as capture spots. Finally, based on the above method, it is proposed a method for diagnosing or monitoring rheumatoid arthritis.

### FIELD OF INVENTION

The present invention relates to methods for the quantification of analytes, in particular, the invention relates to improved microarray methods for the detection and quantification of multiple analytes in a single sample.

### BACKGROUND

Current immunoassay methods are limited as they only detect one target per detection test cycle within a single reaction well. It is common for several antigenic substances or bio-markers to be associated with detection and diagnosis of any pathological or physiological disorder. To confirm the presence of multiple markers, each marker within a test sample requires a separate and different immunoassay to confirm the presence of each target molecule to be detected. This required multitude of tests and samples increases delay in time to treatment, costs and possibility of analytical error. The current state of the art for quantitative multiplexing of proteins/antibodies, especially biomarkers expressed in auto-immune diseases, relies on measuring multiplex antigens.

Enzyme Linked Immunosorbent Assay (ELISA) was developed by Engvall et al., Immunochem. 8: 871 (1971) and further refined by Ljunggren et al. J. Immunol. Meth. 88: 104 (1987) and Kemeny et al., Immunol. Today 7: 67 (1986). ELISA and its applications are well known in the art.

A single ELISA functions to detect a single analyte or antibody using an enzyme-labelled antibody and a chromogenic substrate. To detect more than one analyte in a sample, a separate ELISA is performed to independently detect each analyte. For example, to detect two analytes, two separate ELISA plates or two sets of wells are needed, i.e. a plate or set of wells for each analyte. Prior art chromogenic-based ELISAs detect only one analyte at a time. This is a major limitation for detecting diseases with more than one marker or transgenic organisms which express more than one transgenic product.

Macri, J. N., et al., Ann Clin Biochem 29: 390-396 (1992) describe an indirect assay wherein antibodies (Reagent-1) are reacted first with the analyte and then second labelled anti-antibodies (Reagent-2) are reacted with the antibodies of Reagent 1. The result is a need for two separate washing steps which defeats the purpose of the direct assay.

US2007141656 to Mapes et al. measures the ratio of self-antigen and auto-antibody by comparing to a bead set with monoclonal antibody specific for the self-antigen and a bead set with the self antigen. This method allows at least one analyte to react with a corresponding reactant, i.e. one analyte is a self-antigen and the reactants are auto-antibodies to the self antigen.

Another method for detecting multiple analytes is disclosed in US2005118574 to Chandler et al which makes use of flow cytometric measurement to classify, in real time, simultaneous and automated detection and interpretation of multiple biomolecules or DNA sequences while also reducing costs.

WO0113120 to Chandler and Chandler determines the concentration of several different analytes in a single sample. It is necessary only that there is a unique subpopulation of microparticles for each sample/analyte combination using the flow cytometer. These bead based systems' capability is limited to distinguishing between simultaneous detection of capture antigens.

Simultaneous detection of more than one analyte, i.e. multiplex detection for simultaneous measurement of proteins has been described by Haab et al., “Protein micro-arrays for highly parallel detection and quantization of specific proteins and antibodies in complex solutions,” Genome Biology 2(2): 0004.1-0004.13,(2001), which is incorporated herein by reference. Mixtures of different antibodies and antigens were prepared and labelled with a red fluorescence dye and then mixed with a green fluorescence reference mixture containing the same antibodies and antigens. The observed variation between the red to green ratio was used to reflect the variation in the concentration of the corresponding binding partner in the mixes.

Mezzasoma et al. (Clinical Chemistry 48, 1, 121-130 (2002) published a micro-array format method to detect analytes bound to the same capture in two separate assays, specifically different auto-antibodies reactive to the same antigen. The results revealed that when incubating the captured analytes with one reporter (for example that to detect immunoglobulin IgG), the corresponding analyte is detected. When incubating the captured analytes with the second reporter in an assay using a separate microarray solid-state substrate (for example to detect IgM), a second analyte (IgM) is detected.

WO0250537 to Damaj and Al-assaad discloses a method to detect up to three immobilized concomitant target antigens, bound to requisite antibodies first coated as a mixture onto a solid substrate. A wash step occurs before the first marker is detected. The presence of the first marker may be detected by adding a first specific substrate. The reaction well is read and a color change is detectable with light microscopy. Another wash step occurs before the second marker is detected. The presence of the second marker may be detected by adding a second substrate, specific for the second enzyme, to the reaction well. After sufficient incubation, the reaction well may be assayed for a color change. Similarly, a wash step may occur before the third marker is detected.

The presence of the third marker may be detected by adding a third substrate, specific for the third enzyme, to the reaction well. After sufficient incubation, the reaction well may be assayed for a color change. Although more than one analyte may be detected in a single reaction or test well, each reaction is processed on an individual basis.

WO2005017485 to Geister et al. describes a method to sequentially determine at least two different antigens in a single assay by two different enzymatic reactions of at least two enzyme labelled conjugates with two different chromogenic substrates for the enzymes in the assay (ELISA), which comprises (a) providing a first antibody specific for a first analyte and a second antibody specific for a second analyte immobilized on a solid support; (b) contacting the antibodies immobilized on the solid support with a liquid sample suspected of containing one or both of the antigens for a time sufficient for the antibodies to bind the antigens; (c) removing the solid support from the liquid sample and washing the solid support to remove unbound material; (d) contacting the solid support to a solution comprising a third antibody specific for the first antigen and a fourth antibody specific for the second antigen wherein the third antibody is conjugated to a first enzyme label and the fourth antibody is conjugated to a second enzyme label for a time sufficient for the third and fourth antibodies to bind the analytes bound by the first and second antibodies; (e) removing the solid support from the solution and washing the solid support to remove unbound antibodies; (f) adding a first chromogenic substrate for the first enzyme label wherein conversion of the first chromogenic substrate to a detectable color by the first enzyme label indicates that the sample contains the first analyte; (g) removing the first chromogenic substrate; and (h) adding a second chromogenic substrate for the second enzyme label wherein conversion of the second chromogenic substrate to a detectable color by the second enzyme label indicates that the sample contains the second analyte.

U.S. Pat. No. 7,022,479, 2006 to Wagner, entitled “Sensitive, multiplexed diagnostic assays for protein analysis”, is a method for detecting multiple different compounds in a sample, the method involving: (a) contacting the sample with a mixture of binding reagents, the binding reagents being nucleic acid-protein fusions, each having (i) a protein portion which is known to specifically bind to one of the compounds and (ii) a nucleic acid portion which includes a unique identification tag and which in one embodiment, encodes the protein; (b) allowing the protein portions of the binding reagents and the compounds to form complexes; (c) capturing the binding reagent-compound complexes; (d) amplifying the unique identification tags of the nucleic acid portions of the complex binding reagents; and (e) detecting the unique identification tag of each of the amplified nucleic acids, thereby detecting the corresponding compounds in the sample.

While methods for detecting and quantifying multiple analytes are known, these methods require the use of separate assaying steps for each of the analytes of interest and as such, can be time consuming and costly, especially in the context of a clinical setting.

### SUMMARY OF INVENTION

The present invention provides a fast and cost effective method for detecting and quantifying multiple target analytes in test sample using a single reaction vessel. The method disclosed herein allows for the simultaneous detection of multiple target analytes without the need for separate assays or reaction steps for each target analyte.

In one aspect, the prevent invention provides a method for detecting and quantifying two or more target analytes in a test sample comprising:

a) providing a reaction vessel having a microarray printed thereon, said microarray comprising:
i) a first calibration matrix comprising a plurality of the first calibration spots, each calibration spot comprising a predetermined amount of a first target analyte,
ii) a second calibration matrix comprising a plurality of the second calibration spots, each calibration spot comprising a predetermined amount of a second target analyte,
iii) a first capture matrix comprising a plurality of the first capture spots, each capture spot comprising a predetermined amount of an agent which selectively binds to the first target analyte, and
iv) a second capture matrix comprising a plurality of the second capture spots, each capture spot comprising a predetermined amount of an agent which selectively binds to the second target analyte;

b) applying a predetermined volume of the test sample to the microarray;

c) applying a first fluorescently labelled antibody which selectively binds to the first target analyte and a second fluorescently labelled antibody which selectively binds to the second target analyte to the assay device, wherein said first and second fluorescently labelled antibodies each comprise a different fluorescent dye having emission and excitation spectra which do not overlap with each other;

d) measuring a signal intensity value for each spot within the microarray;

e) generating calibration curves by fitting a curve to the measured signal intensity values for each of the calibration spots versus the known concentrations of the first target analyte and second target analyte; and

f) determining the concentration for the first target analyte and the second target analytes using the generated calibration curves.

In an embodiment of the present invention, the target analytes are proteins. The proteins may be antibodies.

In a further embodiment of the present invention, the reaction vessel is a well of a multi-well plate and wherein each well has the microarray printed therein.

In a further embodiment of the present invention, the test sample is a biological sample.

In another aspect, the present invention provides a method for detecting and quantifying biomarkers diagnostic for rheumatoid arthritis, comprising:

a) providing an assay device having a microarray printed thereon, said microarray comprising:
i) a calibration matrix comprising a plurality of spots, each spot comprising a predetermined amount of one of: a human IgA antibody, a human IgG antibody, and a human IgM antibody;
ii) a first analyte capture matrix comprising a plurality of spots comprising a predetermined amount of rheumatoid factor; and
iii) a second analyte capture matrix comprising a plurality of spots comprising a predetermined amount of cyclic citrullinated peptide;

b) applying a predetermined volume of a serum sample to the assay device;

c) applying a first fluorescently labelled antibody which selectively binds to IgA antibodies, a second fluorescently labelled antibody which selectively binds to IgG antibodies, and a third fluorescently labelled antibody which selectively binds to IgM antibodies to the assay device, wherein said first, second and third fluorescently labelled antibodies each comprise a different fluorescent dye having emission and excitation spectra which do not overlap with each other;

d) measuring a signal intensity value for each spot within the assay device;

e) generating calibration curves by fitting a curve to the measured signal intensity values for the each of the calibration spots versus the known concentration of the human IgA, IgG and IgM antibodies; and

f) determining the concentration for each of captured rheumatoid factor-IgA, rheumatoid factor-IgG, rheumatoid factor-IgM, anti-cyclic citrullinated peptide-IgG, anti-cyclic citrullinated peptide-IgA, and/or anti-cyclic citrullinated peptide-IgM using the calibration curves.

In another aspect, the present invention provides a method for diagnosing rheumatoid arthritis in a subject, comprising:

a) measuring the concentration levels of rheumatoid factor-IgA, rheumatoid factor-IgG, rheumatoid factor-IgM and at least one of anti-cyclic citrullinated peptide-IgG, anti-cyclic citrullinated peptide-IgA, and anti-cyclic citrullinated peptide-IgM in a biological sample, using the method disclosed herein; and

b) comparing the measured concentration levels of rheumatoid factor-IgA, rheumatoid factor-IgG, rheumatoid factor-IgM, anti-cyclic citrullinated peptide-IgG, anti-cyclic citrullinated peptide-IgA, and/or anti-cyclic citrullinated peptide-IgM with index normal levels of rheumatoid factor-IgA, rheumatoid factor-IgG, rheumatoid factor-IgM and anti-cyclic citrullinated peptide-IgG, anti-cyclic citrullinated peptide-IgA, and/or anti-cyclic citrullinated peptide-IgM wherein measured concentrations levels which exceed index normal levels is diagnostic for rheumatoid arthritis.

In an embodiment of the present invention, the detection and quantification of predominantly rheumatoid factor-IgM and anti-cyclic citrullinated peptide-IgM antibodies is diagnostic for an early stage of rheumatoid arthritis.

In a further embodiment of the present invention, the detection and quantification of rheumatoid factor-IgA and anti-cyclic citrullinated peptide-IgA antibodies is diagnostic for a transitional stage of rheumatoid arthritis.

In a further embodiment of the present invention, the detection and quantification of rheumatoid factor-IgG and anti-cyclic citrullinated peptide-IgG antibodies is diagnostic for a late stage of rheumatoid arthritis.

In another aspect, the present invention provides a method for monitoring rheumatoid arthritis treatment in a subject suffering therefrom, comprising measuring the concentration levels of rheumatoid factor-IgA, rheumatoid factor-IgG, rheumatoid factor-IgM and at least one of anti-cyclic citrullinated peptide-IgG, anti-cyclic citrullinated peptide-IgA, and anti-cyclic citrullinated peptide-IgM using the method disclosed herein, a plurality of times during the treatment.

### BRIEF DESCRIPTION OF THE DRAWINGS

Preferred embodiments of the invention will now be described, by way of example, with reference to the accompanying drawings, in which:

FIG. 1 is a schematic illustration of the multiplex analyte detection method of the present invention;

FIG. 2 is a bar graph plotting the ratio of the average measured fluorescence intensity for captured IgA against the average measured fluorescence intensity for IgM internal calibrator for two samples, NS and RF#3;

FIG. 3 is a bar graph plotting the ratio of the average measured fluorescence intensity for captured IgM against the average measured fluorescence intensity for IgM internal calibrator for two samples, NS and RF#3; and

FIG. 4 is a plot comparing the composite fluorescent intensities for IgA, IgG and IgM antibodies using the method of the present invention.

### DESCRIPTION

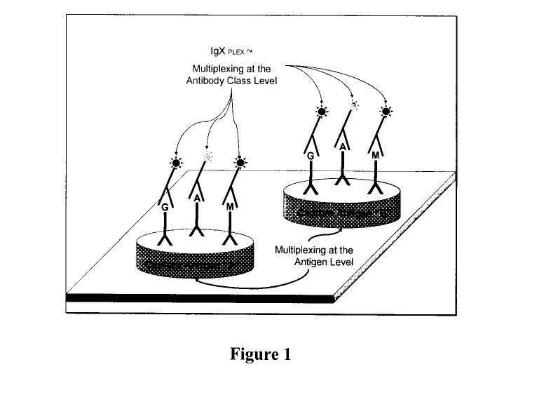

The present invention provides a method for the detection and quantification of multiple target analytes in a test sample, within a single reaction well, per test cycle. The method disclosed herein provides for the simultaneous incubation of an assay device with two or more fluorescently labelled reporters in the same detection mixture as shown in FIG. 1. The method disclosed herein can detect more than one analyte in using a single reaction vessel instead of separate reaction vessels to detect each analyte. For example, when the target analytes of interest are different classes of human antibodies (i.e. hIgG, hIgA, and hIgM) directed to the same antigen (i.e. the Fc region of hIgG), the detection and quantification of each of the target antibodies requires separate assays when convention methods are employed. With conventional methods, one assay is performed to detect and quantify the amount of hIgG present in the test sample. A second assay must be performed to detect and quantify the amount of hIgM and a third assay must be performed to detect and quantify the amount of hIgG. In contrast, the method of the present invention eliminates the need for multiple detection steps thus reducing costs and time. Using the method of the present invention, target hIgG, hIgA and hIgM molecules contained in a test sample can be bound to as single capture spot in an assay device. In the disclosed method, the different classes of antibodies can be detected in a single test by using a cocktail of fluorescently labelled antibodies directed to each of the hIgG, hIgM and hIgA targets. As the antibodies are labelled with different optically excited and emitted fluorescent probes, the each of the targets bound to a single capture spot can be detected and quantified using an appropriate calibrator. The use of multi-channel detectors allows for substantially simultaneous detection of multiple analytes in a single assay.

The methods disclosed herein employ assay devices useful for conducting immunoassays. The assay devices may be microarrays in 2 or 3-dimensional planar array format.

In one embodiment, the method may employ the use of a multi-well plate and wherein each well has a microarray printed therein. A single well is used as a reaction vessel for assaying the desired plurality of target analytes for each test sample.

The microarray may comprise a calibration matrix and an analyte capture matrix for each target analyte.

As used herein, the term “calibration matrix” refers to a subarray of spots, wherein each spot comprises a predetermined amount of a calibration standard. The term “predetermined amount” as used herein, refers to the amount of the calibration standard as calculated based on the known concentration of the spotting buffer comprising the calibration standard and the known volume of the spotting buffer printed on the reaction vessel.

The choice of the calibration standard will depend on the nature of the target analyte. The calibration standard may be the target analyte itself in which case, the calibration standard. In such embodiments, the microarray will comprise a separate calibration standard for each target analyte. Alternatively, the microarray may comprise a single calibration matrix having calibration spots containing each of the target analytes.

In alternate embodiments, the calibration standard is a surrogate compound. For example if the target analyte is an antibody, the surrogate compound may be another different antibody but of the same class of immunoglobulin. For example, FIG. 1 illustrates an assay device useful for capturing six different antibodies which selectively bind to two different antigens. In such embodiments, only one calibration matrix may be required for each of the three different classes of immunoglobulins.

The calibration matrix may be printed on the base of the individual reaction vessel in the form of a linear, proportional dilution series with the predetermined amounts of the calibration standard falling within the dynamic range of the detection system used to read the microarray.

As used herein, the term “analyte capture matrix” refers to a subarray of spots comprising an agent which selectively binds to the target analyte. In embodiments where the target analyte is a protein, the agent may be an analyte specific antibody or fragment thereof Conversely, in embodiments wherein the target analyte is an antibody, the agent may be an antigen specifically bound by the antibody. For example, FIG. 1 illustrates an assay device useful for capturing six different antibodies which selectively bind to two different antigens.

A predetermined volume of a test sample is applied to the assay device. The each of the target analytes will bind to their specific capture spot. Thus, in a single capture spot, multiple target analytes may be bound. To detect each of the target analytes, a fluorescently labelled antibody which specifically binds to the target analyte is used. Each antibody is coupled to a unique fluorescent dye with a specific excitation and emission wavelength to obtain the desired Stokes shift and excitation and emission coefficients. The fluorescent dyes are chosen based on their respective excitation and emission spectra such that each of the labelled antibodies comprises a different fluorescent dye having emission and excitation spectra which do not overlap with each other. The fluorescently labelled antibodies can be applied to the assay device in a single step in the form of a cocktail.

A signal intensity value for each spot within the assay device is then measured. The fluorescent signals can be read using a combination of scanner components such as light sources and filters. A signal detector can be used to read one optical channel at a time such that each spot is imaged with multiple wavelengths, each wavelength being specific for a target analyte. An optical channel is a combination of an excitation source and an excitation filter, matched for the excitation at a specific wavelength. The emission filter and emission detector pass only a signal wavelength for a specific fluorescent dye. The optical channels used for a set of detectors are selected such that they do not interfere with each other, i.e. the excitation through one channel excites only the intended dye, not any other dyes. Alternatively, a multi-channel detector can be used to detect each of the differentially labelled antibodies. The use of differential fluorescent labels allows for substantially simultaneous detection of the multiple target analytes bound to a single capture spot.

The intensity of the measured signal is directly proportional to the amount of material contained within the printed calibration spots and the amount of analyte from the test sample bound to the printed analyte capture spot. For each calibration compound, a calibration curve is generated by fitting a curve to the measured signal intensity values versus the known concentration of the calibration compound. The concentration for each target analyte in the test sample is then determined using the appropriate calibration curve and by plotting the measured signal intensity for the target analyte on the calibration curve.

The method disclosed herein can be used to detect and quantify multiple clinically relevant biomarkers in a biological sample for diagnostic or prognostic purposes. The measured concentrations for a disease related biomarker can be compared with established index normal levels for that biomarker. The measured concentrations levels which exceed index normal levels may be identified as being diagnostic of the disease. The method disclosed herein can also be used to monitor the progress of a disease and also the effect of a treatment on the disease. Levels of a clinically relevant biomarker can be quantified using the disclosed method a plurality of times during a period of treatment. A trending decrease in biomarker levels may be correlated with a positive patient response to treatment.

The method disclosed herein can be used to detect and quantify biomarkers diagnostic for rheumatoid arthritis. In one embodiment, the method comprises the provision of an assay device having a microarray printed thereon. The microarray may comprise: i) a calibration matrix comprising plurality of spots, each spot comprising a predetermined amount of one of: a human IgA antibody, a human IgG antibody, and a human IgM antibody; ii) a first analyte capture matrix comprising a plurality of spots comprising a predetermined amount of rheumatoid factor; and iii) a second analyte capture matrix comprising a plurality of spots comprising a predetermined amount of cyclic citrullinated peptide. A predetermined volume of a biological sample, preferably a serum sample, is applied to the assay device. A cocktail comprising a first fluorescently labelled reporter compound which selectively binds to IgA antibodies, a second fluorescently labelled reporter compound which selectively binds to IgG antibodies, and a third fluorescently labelled reporter compound which selectively binds to IgM antibodies is then applied to the assay device. The first, second and third fluorescently labelled antibodies are chosen such that each of the antibodies comprise a different fluorescent dye having emission and excitation spectra which do not overlap with each other. A signal intensity value for each spot within the assay device is then measured using a single or multi-channel detector as discussed above. Using the measured signal intensity values, calibration curves are then generated by fitting a curve to the measured signal intensity values for the each of the calibration spots versus the known concentration of the human IgA, IgG and IgM antibodies. The concentration for each of captured rheumatoid factor-IgA, rheumatoid factor-IgG, rheumatoid factor-IgM, anti-cyclic citrullinated peptide-IgG, anti-cyclic citrullinated peptide-IgA, and/or anti-cyclic citrullinated peptide-IgM is the determined using the calibration curves.

In certain embodiments, the method disclosed herein can be used to diagnose or monitor the progress of autoimmune diseases. For example, in the case of rheumatoid arthritis, the detection and quantification of predominantly rheumatoid factor-IgM and anti-cyclic citrullinated peptide-IgM antibodies is diagnostic for an early stage of rheumatoid arthritis whereas the detection and quantification of rheumatoid factor-IgA and anti-cyclic citrullinated peptide-IgA antibodies is diagnostic for a transitional stage of disease progression and the detection and quantification of rheumatoid factor-IgG and anti-cyclic citrullinated peptide-IgG antibodies is diagnostic for a late stage of disease progression. In other embodiments, the method disclosed herein can be used to monitoring the progress of treatment in a subject suffering from rheumatoid arthritis. For example, the concentration levels of rheumatoid factor-IgA, rheumatoid factor-IgG, rheumatoid factor-IgM and at least one of anti-cyclic citrullinated peptide-IgG, anti-cyclic citrullinated peptide-IgA, and anti-cyclic citrullinated peptide-IgM can be measured a plurality of times during the treatment.

### EXAMPLE 1

### Detection and Quantification of Three Different Target Antibodies in a Serum Sample

Four concentrations each of human IgM, IgG, IgA are printed in the same sample well on a 16-well slide, pretreated to create an epoxysilane substrate surface. The protein printed slides were incubated overnight with fish gelatin to block unreacted epoxysilane binding sites in the well.

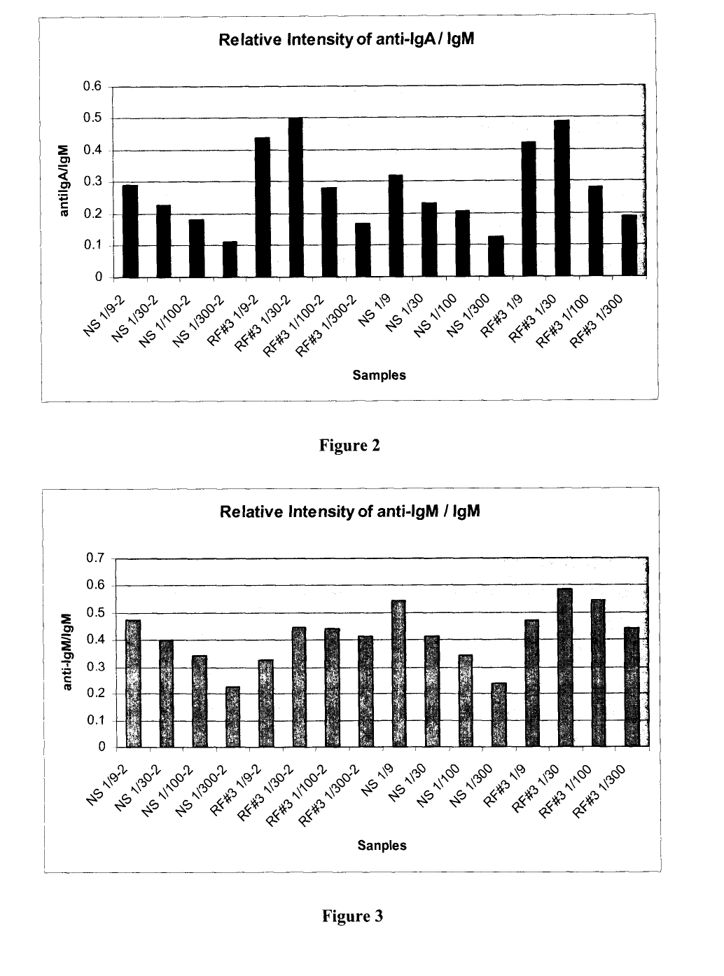

To perform the assay, serum samples were diluted 1 in 9 to 1 in 200 in buffers containing fish gelatin. Each sample was diluted to four dilutions, 1:9, 1:30, 1:100, 1:300 in duplicate. The two diluted samples (named NS and RF #3, see FIGS. 2 and 3) were incubated for 45 min. The slide was washed five times, in Tris buffered saline. A cocktail of goat antihuman antibody conjugated to FITC, two mouse antihuman IgA antibodies conjugated to DY652 (Dyomics, Germany), and a mouse antihuman IgG antibody conjugated to Cy3 dye, each in about 1 μg/ml concentration, was added to all wells of the slide.

The reagent was incubated for 45 minutes, followed by a five fold wash. The slide was finally spun dry and read in a fluorescent image scanner to read fluorescence emission intensity for the three combinations of excitation and emission wavelengths. The resulting images were analyzed to derive each analyte concentration.

The detection of IgA RF is shown in FIG. 2, which plots the average of fluorescent signals for the captured IgA signal was divided with the average of the calibrator signals for an IgM calibrator and the resulting ratio plotted against the sample/dilution. The eight bars on the left side denote the 8 wells on the left side of a slide and the eight bars on the right side denotes the 8 wells on the right side of a sixteen well slide.

The detection of IgM RF is shown in FIG. 3, which plots the average of fluorescent signals for the captured IgM signal was divided with the average of the calibrator signals for an IgM calibrator and the resulting ratio plotted against the sample/dilution. The eight bars on the left side denote the 8 wells on the left side of a slide and the eight bars on the right side denotes the 8 wells on the right side of a sixteen well slide.

As seen in FIGS. 2 and 3, the ratio of IgA (FIG. 2) and IgM (FIG. 3) signal, when compared to the calibrator signal decreased in proportion to the test sample dilutions, from 1 in 9 to 1 in 200. These results validate the detection and quantification IgA and IgM using differential fluorescent labelled antibodies in a single assay and without multiple detection steps. In addition, the left and right columns on the slide confirmed consistent results between the corresponding duplicates.

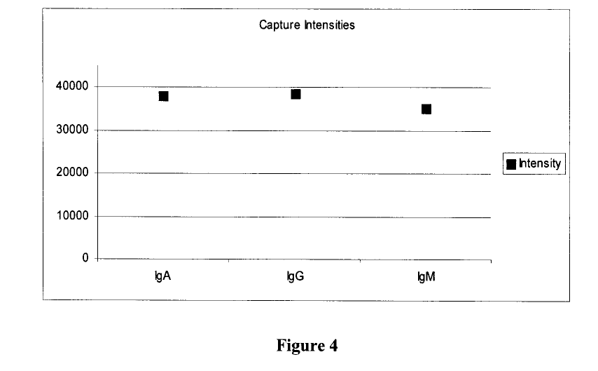

FIG. 4 shows the respective composite signal intensities for each of the IgA, IgM and IgG capture spots. These results demonstrate validate multiplexing at both the capture level and at the detection level.

Various embodiments of the present invention having been thus described in detail by way of example, it will be apparent to those skilled in the art that variations and modifications may be made without departing from the invention. The invention includes all such variations and modifications as fall within the scope of the appended claims.

1. A method for detecting and quantifying two or more target analytes in a test sample, the method comprising:
a) providing a reaction vessel having a microarray printed thereon, said microarray comprising:
i) a first calibration matrix comprising a plurality of first calibration spots, each calibration spot comprising a predetermined amount of a first target analyte,
ii) a second calibration matrix comprising a plurality of second calibration spots, each calibration spot comprising a predetermined amount of a second target analyte,
iii) a first capture matrix comprising a plurality of first capture spots, each capture spot comprising a predetermined amount of an agent which selectively binds to a first target analyte, and
iv) a second capture matrix comprising a plurality of second capture spots, each capture spot comprising a predetermined amount of an agent which selectively binds to a second target analyte;
b) applying a predetermined volume of the test sample to the microarray;
c) applying a first fluorescently labelled antibody that selectively binds to the first target analyte and a second fluorescently labelled antibody that selectively binds to the second target analyte to the assay device, wherein said first and second fluorescently labelled antibodies each comprise a different fluorescent dye having emission and excitation spectra which do not overlap with each other;
d) measuring a signal intensity value for each spot within the microarray;
e) generating calibration curves by fitting a curve to the measured signal intensity values for each of the calibration spots versus the known concentrations of the first target analyte and second target analyte; and
determining the concentration for the first target analyte and the second target analytes utilizing the generated calibration curves.

2. The method according to claim 1, wherein the target analytes are proteins.

3. The method according to claim 2, wherein the proteins are antibodies.

4. The method according to claim 3, wherein the reaction vessel is a well of a multi-well plate and wherein each well has the microarray printed therein.

5. The method according to claim 1 wherein the test sample is a biological sample.

6. A method for detecting and quantifying biomarkers diagnostic for rheumatoid arthritis, the method comprising:
a) providing an assay device having a microarray printed thereon, said microarray comprising:
i) a calibration matrix comprising a plurality of spots, each spot comprising a predetermined amount of one of: a human IgA antibody, a human IgG antibody, and a human IgM antibody;
ii) a first analyte capture matrix comprising a plurality of spots comprising a predetermined amount of rheumatoid factor; and
iii) a second analyte capture matrix comprising a plurality of spots comprising a predetermined amount of cyclic citrullinated peptide;
b) applying a predetermined volume of a serum sample to the assay device;
c) applying a first fluorescently labelled antibody which selectively binds to IgA antibodies, a second fluorescently labelled antibody which selectively binds to IgG antibodies, and a third fluorescently labelled antibody which selectively binds to IgM antibodies to the assay device, wherein said first, second and third fluorescently labelled antibodies each comprise a different fluorescent dye having emission and excitation spectra which do not overlap with each other;
d) measuring a signal intensity value for each spot within the assay device;
e) generating calibration curves by fitting a curve to the measured signal intensity values for the each of the calibration spots versus the known concentration of the human IgA, IgG and IgM antibodies; and
f) determining the concentration for each of captured rheumatoid factor-IgA, rheumatoid factor-IgG, rheumatoid factor-IgM, anti-cyclic citrullinated peptide-IgG, anti-cyclic citrullinated peptide-IgA, and/or anti-cyclic citrullinated peptide-IgM using utilizing the calibration curves;

7. A method for diagnosing rheumatoid arthritis in a subject, the method comprising:
a) measuring the concentration levels of rheumatoid factor-IgA, rheumatoid factor-IgG, rheumatoid factor-IgM and at least one of anti-cyclic citrullinated peptide-IgG, anti-cyclic citrullinated peptide-IgA, and anti-cyclic citrullinated peptide-IgM in a biological sample, utilizing the method according to claim 6; and
b) comparing the measured concentration levels of rheumatoid factor-IgA, rheumatoid factor-IgG, rheumatoid factor-IgM, anti-cyclic citrullinated peptide-IgG, anti-cyclic citrullinated peptide-IgA, and/or anti-cyclic citrullinated peptide-IgM with index normal levels of rheumatoid factor-IgA, rheumatoid factor-IgG, rheumatoid factor-IgM and anti-cyclic citrullinated peptide-IgG, anti-cyclic citrullinated peptide-IgA, and/or anti-cyclic citrullinated peptide-IgM wherein measured concentrations levels which exceed index normal levels is diagnostic for rheumatoid arthritis.

8. The method of claim 7, wherein detection and quantification of predominantly rheumatoid factor-IgM and anti-cyclic citrullinated peptide-IgM antibodies is diagnostic for an early stage of rheumatoid arthritis.

9. The method of claim 7, wherein the detection and quantification of rheumatoid factor-IgA and anti-cyclic citrullinated peptide-IgA antibodies is diagnostic for a transitional stage of rheumatoid arthritis.

10. The method of claim 7, wherein the detection and quantification of rheumatoid factor-IgG and anti-cyclic citrullinated peptide-IgG antibodies is diagnostic for a late stage of rheumatoid arthritis.

11. The method according to claim 6, further comprising monitoring rheumatoid arthritis treatment in a subject suffering therefrom by:
measuring the concentration levels of rheumatoid factor-IgA, rheumatoid factor-IgG, rheumatoid factor-IgM, and at least one of anti-cyclic citrullinated peptide-IgG, anti-cyclic citrullinated peptide-IgA, and anti-cyclic citrullinated peptide-IgM, a plurality of times during the treatment.

12. The method according to claim 2, wherein the test sample is a biological sample.

13. The method according to claim 3, wherein the test sample is a biological sample.

14. The method according to claim 4, wherein the test sample is a biological sample.
